(19) United States
(12) Patent Application Publication
(10) Pub. No.: US 2005/0153754 A1
(43) Pub. Date: Jul. 14, 2005

(54) Magnetic field device

(76) Inventors: Steve C. Shanks, Mesa, AZ (US); George Leger, Mesa, AZ (US)

Correspondence Address: ETHERTON LAW GROUP, LLC, 5555 E. VAN BUREN STREET, SUITE 100, PHOENIX, AZ, 85008, US

(21) Appl. No.: 10/756,659

(22) Filed: Jan. 12, 2004

(51) Int. Cl. H04M 1/00

(52) U.S. Cl. 455/575.5; 455/550.1

(57) ABSTRACT

A magnetic field device for counteracting the harmful effects of electromagnetic radiation. A pulse generator is used to produce radio and visible frequencies at a desired pulse rate. The preferred embodiment of the magnetic field device attaches to a cell phone and utilizes ambient radio waves as the power source.

### FIELD OF INVENTION

This invention relates generally to magnetic field devices. This invention relates particularly to devices producing magnetic fields for therapeutic use.

### BACKGROUND

The earth is bathed in radiation from electromagnetic fields, both those that are naturally occurring and those that are generated by machine. For example, a cell phone user's head is exposed to the electromagnetic field that is generated when a cell phone is on. Radiation from certain electromagnetic fields is considered harmful to humans.

Devices for balancing the ambient electromagnetic field are known. In one application, several electromagnetic field sources are utilized to produce balancing fields. Devices for offsetting the dangerous radiation emanating from motor vehicles and cathode-ray tubes are also known. These devices typically use batteries as a power source. For this and other reasons, these devices are inconvenient and not portable.

The Schuman frequency corresponds to the frequency of the geomagnetic field of the earth. Many of the known devices produce Schuman-frequency waves for a prolonged period of time in an effort to counteract the impinging radiation. As with the other known devices, however, the Schuman devices are powered by batteries and are not portable. It would be desirable to have a device that provides protection from electromagnetic field generating devices that uses a power source other than batteries and that conveniently attaches to a cell phone or is otherwise portable.

Therefore, it is an object of this invention to provide a device to provide protection from the harmful effects of radiation. It is a further object to provide a device utilizing ambient radiation as its power source. It is a further object to provide a device utilizing radio waves transmitted by cell phones as a power source. Another object is to provide a device which conveniently attaches to a cell phone. A further object of the invention is to generate both radio and light frequencies which offset the harmful effects of electromagnetic radiation.

### SUMMARY OF THE INVENTION

The present invention is a magnetic field device for counteracting the harmful effects of electromagnetic radiation. A pulse generator is used to produce radio and visible frequencies at a desired pulse rate. The preferred embodiment of the magnetic field device attaches to a cell phone and utilizes ambient radio waves as the power source. The power source preferably utilizes diodes, a capacitor, and a radio frequency receiver. The device also utilizes a pulse generator, preferably an oscillator and a microprocessor, to generate both radio and light pulses, preferably at the Schuman frequency.

### BRIEF DESCRIPTION OF THE DRAWINGS

FIG. 1 is a front view of a cell phone and a cell phone user.

FIG. 2 is a perspective view of the present invention attached to a cell phone.

FIG. 3 is a schematic view of the preferred embodiment of the present invention.

### DETAILED DESCRIPTION OF THE INVENTION

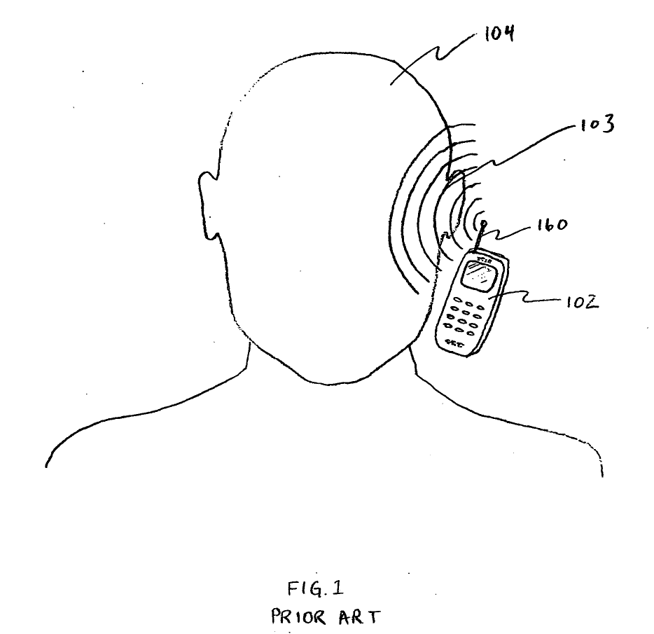

Referring to FIGS. 1-3, device 100 comprises power source 106 and pulse generator 108 and is used to counteract the harmful effects of electromagnetic radiation. In the preferred embodiment, device 100 is used to counteract the electromagnetic radiation 103 created by a cell phone 102, as shown in FIG. 1. Considering issues such as technology, safety, cost, etc., other forms of electromagnetic radiation 103, such as radio waves, microwaves, infrared, visible, ultraviolet, x-ray, gamma, etc., may also be counteracted. Device 100 preferably generates electromagnetic radiation in pulses up to 69 Hz, but preferably at the Schuman frequency, which on average is about 7.83 Hz. Device 100 is preferably attached near a primary source of the electromagnetic radiation 103 which, on a cell phone, is the antenna 160. Of course, the device can be powered exclusively from ambient radiation if it is sufficient. Device 100 may be used in conjunction with sources of harmful radiation other than cell phones, such as televisions, power lines, other transmitters, other receivers, microwaves, etc.

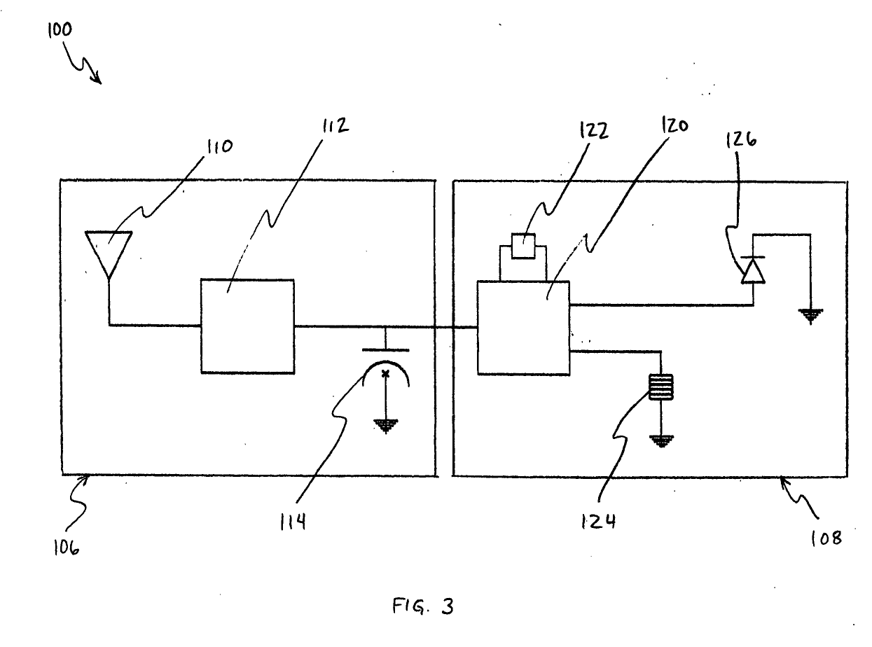

Power source 106 preferably comprises receiver 110, at least one diode 112, and capacitor 114, as shown in FIG. 3. Electromagnetic energy, primarily radio frequency, transmissions from the cell phone antenna 160 are received by receiver 110 and provide the energy for power source 106. Receiver 110 is preferably an antenna, such as a micro-strip or lead on an integrated circuit or a lead off of a circuit board. Diode 112 is preferably two to four high-frequency Schottky diodes. Capacitor 114 is used to store power and is preferably a 1 microfarad capacitor. Under appropriate circumstances, considering issues such as cost, technology, market demand, safety, etc., other power sources 106, such as batteries, kinetic energy, solar energy, etc., may suffice.

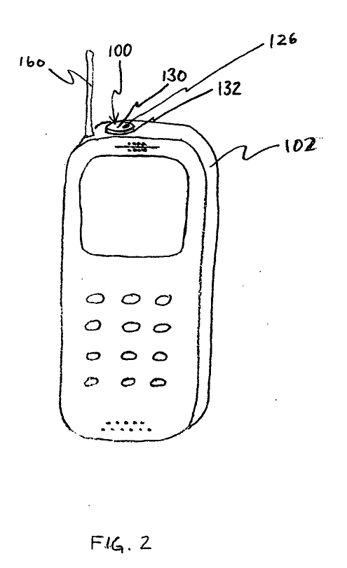

The pulse generator 108 is the means for generating electromagnetic radiation in pulses. Pulse generator 108 preferably comprises processor 120, oscillator 122, inductor 124, and light emitting diode 126, as shown in FIG. 3. Pulse generator 108 provides at least one frequency up to about 69 Hz and the radiation is typically generated in a sphere. The energy can be directed to a more limited scope, such as encompassing only the portion of a cell phone user's head exposed to the cell phone's radiation. Processor 120 is preferably a microprocessor, such as a Microchip Company PIC-629 processor, preferably operating in the lowest power mode. Oscillator 122 is preferably a 32.768 kilohertz crystal. Inductor 124 is preferably a 10 millihenry coil used to produce a magnetic field at the Schuman frequency. Light emitting diode 126 preferably emits red light having a 635 nanometer wavelength, pulsing at the Schuman frequency. As shown in FIG. 2, light emitting diode 126 also provides an indication that device 100 is working. Under appropriate circumstances other pulse generators 108 such as inductor-capacitor, rubidium, oven-controlled, voltage-controlled, clock, temperature compensated, pulse generators producing other frequencies, etc., may suffice.

Device 100 preferably comprises a housing 130 and an attacher 132, as shown in FIG. 2. Housing 130 is preferably a disc-shaped housing with an about 0.5 inch diameter. Attacher 132 is preferably an adhesive, covering a single face of disk-shaped housing 130, allowing device 100 to be adhesively attached to the exterior of any cell phone 102, generally at the base of the cell phone antenna 160, as shown in FIG. 2. Under appropriate circumstances, considering issues such as technology, cost, safety, convenience to a cell phone user 104, market demand, etc., other attachers 132, such as attachers on the interior of cell phone 102, attachers integrating device 100 with the circuitry of cell phone 102, attachers located near the radiation source, attachers located on the human body and attachers comprising snaps, sliders, magnets, etc., may suffice.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

1. A magnetic field device comprising:
a) means for generating power from ambient electromagnetic radiation; and
b) means for generating electromagnetic radiation in pulses.

2. A magnetic field device comprising:
a) a power source that utilizes ambient electromagnetic radiation to generate power; and
b) a pulse generator.

3. The device according to claim 2 wherein the ambient electromagnetic radiation is generated by a cell phone.

4. The device according to claim 2 wherein the power source comprises an antenna.

5. The device according to claim 2 wherein the power source comprises a diode.

6. The device according to claim 2 wherein the power source comprises a capacitor.

7. The device according to claim 2 wherein the pulse generator produces pulses at a frequency of up to about 69 Hz.

8. The device according to claim 7 wherein the frequency produced is the Schuman frequency.

9. The device according to claim 2 wherein the pulse generator comprises a processor.

10. The device according to claim 2 wherein the pulse generator comprises an oscillator.

11. The device according to claim 10 wherein the oscillator is a crystal.

12. The device according to claim 2 wherein the pulse generator comprises an inductor.

13. The device according to claim 12 wherein the inductor is a coil.

14. The device according to claim 2 wherein the pulse generator comprises a light emitting diode.

15. The device according to claim 2 further comprising an attacher.

16. The device according to claim 15 wherein the attacher is adhesive.

17. The device according to claim 2 further comprising a housing.

18. The device according to claim 2 wherein the device is attached near a cell phone antenna.

19. A magnetic field device comprising:
a) a power source;
b) a pulse generator; and
c) an attacher adapted to attach the device to a source of electromagnetic radiation.

20. The device according to claim 19 wherein the power source is ambient electromagnetic radiation.

21. The device according to claim 19 wherein the source of electromagnetic radiation is a cell phone.

22. The device according to claim 19 further comprising:
a) a disc-shaped housing; wherein
the attacher is an adhesive;
the power source comprises,
i) an antenna,
ii) at least one diode, and
iii) a capacitor;
the pulse generator produces pulses at the Schuman frequency; and
the pulse generator comprises:
i) a microprocessor,
ii) a crystal oscillator,
iii) a coil inductor, and
iv) a light emitting diode.
